(19) United States
(12) Patent Application Publication
(10) Pub. No.: US 2011/0067671 A1
(43) Pub. Date: Mar. 24, 2011

(54) Non-soot emitting fuel combustion chamber

(76) Inventor: Franz J. Laimboeck, Goleta, CA (US)

(21) Appl. No.: 12/807,359

(22) Filed: Sep. 1, 2010

Related U.S. Application Data
(60) Provisional application No. 61/275,813, filed on Sep. 1, 2009.
(60) Provisional application No. 61/275,813, filed on Sep. 1, 2009.

(51) Int. Cl. F02B 3/00; F02F 3/00

(52) U.S. Cl. 123/298; 123/193.6

(57) ABSTRACT

An embodiment of the invention provides a combustion chamber for non-soot emitting fuel. The combustion chamber includes a piston bowl, and a fuel injector mounted through a cylinder wall of a cylinder with the piston bowl, wherein the fuel injector injects fuel against a wall of the piston bowl in at least a substantially tangential manner.

### CROSS-REFERENCE TO RELATED APPLICATION

This application claims a priority to and claims the benefit of U.S. Provisional Application No. 61/275,813. U.S. Provisional Application No. 61/275,813 is incorporated herein by reference in its entirety.

### BACKGROUND

Soot is emitted from the combustion of fuel with carbon content, such as gasoline or diesel. Diesel, in particular, has rich carbon content that leads to soot emission during combustion. In contrast, the combustion of alcohol fuel and ammonia does not emit soot because carbon is not present in these types of non-soot producing fuel. When fuel does not have carbon, the only available carbon element is from the CO₂ molecule in the air, and there is no soot emission because of the oxygen content in the molecule.

The Meurer combustion system provides a narrowed focused fuel spray that impinges and is entrained on the combustion chamber wall of a piston bowl. Therefore, the piston bowl is wet with fuel that rotates in the same sense (direction) as the air swirl within the piston bowl. As the piston approaches top dead center (TDC), the air swirl moves from the cylinder into the piston bowl and increases in rotation velocity. The air swirl will skim off the fuel from the chamber wall, in a layer by layer manner. The skimmed fuel is then introduced for combustion. Since the Meurer combustion system uses diesel, high soot emission occurs from combustion. While the Meurer combustion system is multi-fuel type suitable and has a low pressure gradient, soot emission is a problem with this combustion system.

The human sense of smell can detect very low concentrations of aldehydes which are partly-burned hydrocarbons. An after-treatment stage is typically implemented in current combustion systems in order to reduce or eliminate the aldehydes emitted from combustion. As a result, the after-treatment stage prevents the human sense of smell from detecting the unpleasant scent of aldehydes. Therefore, current combustion systems typically require the use of this additional after-treatment stage in order to eliminate the aldehydes that are emitted during combustion.

One current combustion system that uses fuel impingement on the combustion chamber wall and that uses ethanol is commercially available from Scania AB. However, this current combustion system is only limited to piston engines with a normal cylinder head and the single piston per cylinder arrangement.

Therefore, improvements in the current technology would be desirable in order to overcome current constraints or deficiencies.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1A is a top view of a non-soot emitting fuel combustion chamber, in accordance with an embodiment of the invention.

FIG. 1B is a top view of a non-soot emitting fuel combustion chamber, in accordance with another embodiment of the invention.

FIG. 2A is a partial side elevational view of an ignition source pocket in a non-soot emitting fuel combustion chamber, in accordance with an embodiment of the invention.

FIG. 2B is a partial side elevational view of an ignition source pocket in a non-soot emitting fuel combustion chamber, in accordance with another embodiment of the invention.

FIG. 3 is a perspective view of a non-soot emitting fuel combustion chamber, in accordance with an embodiment of the invention.

FIG. 4 is an axial cross-sectional view of a piston bowl as implemented with a cylinder in a horizontal layout, in accordance with an embodiment of the invention.

FIG. 5 is an additional perspective view of a piston bowl, in accordance with an embodiment of the invention.

FIG. 6 is an additional isometric view of a piston bowl, in accordance with an embodiment of the invention.

FIG. 7 is an additional perspective view of a piston bowl, in accordance with an embodiment of the invention.

FIG. 8 is a cross-sectional view of an opposed piston arrangement that can be used in an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

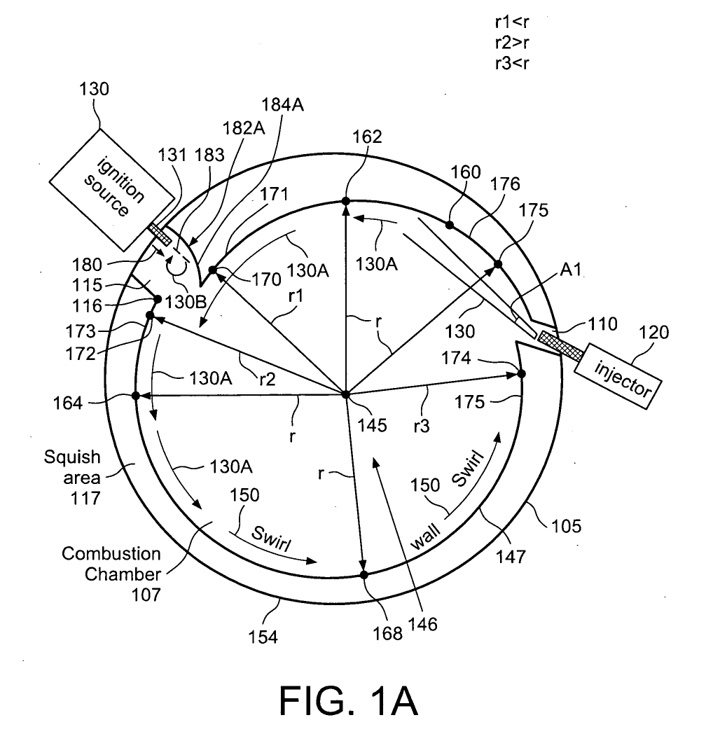

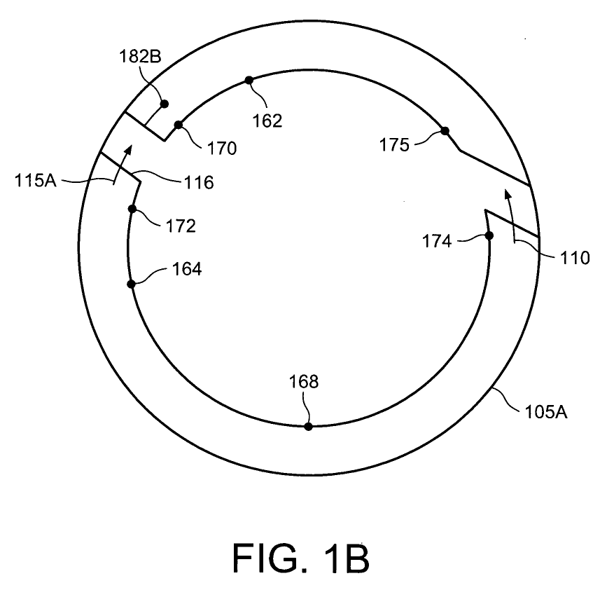

FIG. 1 is a top cross-sectional view of an apparatus 100 in accordance with an embodiment of the invention. A piston bowl 105 forms a combustion chamber 107, in accordance with an embodiment of the invention. An embodiment of the invention is suitable for use with opposed-piston engines and also suitable for use with piston engines with the single piston per cylinder arrangement. The piston bowl 105 is injected with non-soot emitting fuel such as, for example, alcohol fuel (e.g., ethanol, methanol, ISO buthanol, D.M.E. or other alcohol fuel types) or ammonia (NH₃). Alcohol fuel has a higher octane number than gasoline or diesel. Both alcohol fuel and ammonia do not produce soot because these types of fuel do not contain carbon. Another advantage of using alcohol fuel is that due to the properties of various types of alcohol, a high compression ratio and high boost pressure can be used without causing engine knock.

The piston bowl 105 includes a fuel injector pocket (injector recess) 110 and an ignition source pocket (ignition source recess) 115 on a squish area 117. The details of the pockets 110 and 115 are discussed below. A fuel injector 120 injects a fuel plume (fuel spray) 130 through the injector pocket 110 and the ignition source 130 would provide ignition to the vaporized fuel. The fuel injector 120 can be, for example, a GDI (gasoline) injector and provides pressure in the range of, for example, approximately 100 bar to approximate 300 bar. However, the fuel injector 120 can also be of the type that provides a higher amount of pressure that is greater than 300 bar. For example, the fuel injector 120 can provide a pressure amount of approximately 1000 bar which is the capability of typical diesel injectors. As will be discussed below and shown in subsequent drawings, the injector 120 is mounted through the cylinder wall (cylinder liner) of a cylinder with the piston bowl 105.

The ignition source 130 supplies a catalyst for igniting the vaporized fuel. The ignition source 130 is, for example, a spark plug that provides sparks for fuel ignition, a laser source that provides a laser signal for fuel ignition, an electrical source type that provides an electrical signal or voltage/current for fuel ignition, or other suitable types of ignition sources that are currently available or that may be developed as technology improves. As a non-limiting example, the ignition source 130 is a multi-spark ignition system or provides one spark per crank angle. The thread of the ignition source 130 can be, for example, 10×1.5.

Additionally, in an embodiment of the invention, the piston bowl 105 preferably has its center 145 in the same axis as the center of the cylinder. The center 145 is within the center portion 146 of the piston bowl 105. However, in other embodiments of the invention, the piston bowl center 145 is not required to be in the same axis as the center of the cylinder and can be located at an offset position from the axis of the cylinder center.

The fuel injector 120 injects the non-soot emitting fuel (e.g., alcohol or ammonia) onto the chamber wall 147 (piston wall 147) as a focused fuel plume 130 with a narrow plume angle A1. As an example, the angle A1 is approximately 5 degrees or less. The plume 130 has an impulse that creates momentum for fuel rotation along the wall 147. A higher injection pressure from the injection source 120 for the fuel plume 130 will result in an increase impulse that will cause the fuel to rotate along the wall 147 at an increased duration as long as the liquid state of the fuel is not vaporized.

The piston wall 147 forms the boundary of the piston bowl 105. Preferably, the injector 120 is positioned (or is aimed) so that the plume 130 will come into contact with the wall 147 in a tangential manner 140 or in a substantially tangential manner 140 in order to maintain the momentum of the fuel plume 130 along the wall 147 and reduce the reflection (splashing off) of the fuel plume 130 from the wall 147. Therefore, the plume 130 will at least substantially follow the curvature of the wall 147. If the fuel plume 130 comes into contact against the wall 147 in at least a substantially tangential manner 140, the momentum (rotation) of the liquid fuel 130A along the wall 147 is substantially conserved because the liquid fuel 130A will be entrained and will rotate along the curvature of the wall 147, and the reflection of the liquid fuel 130A from the wall 147 toward the bowl 136 is minimized. It is desirable to minimize any reflected (splashed) liquid fuel from the wall 147 because any reflected liquid fuel will lose its momentum of its rotation along the wall 147. It is desirable that the liquid fuel 130A maintains its momentum of rotation along the wall 147 until the liquid fuel 130A is drawn into the pocket 115 as vaporized fuel 130B prior to combustion.

The aim of the injector 120 is typically not directed toward the center 145 of the bowl 105, so that the plume 130 can hit the wall 147 in a substantially tangential manner 140. In one embodiment of the invention, the injector 120 is inclined toward the axis of the cylinder that contains the piston 105. In another embodiment of the invention, the injector 120 is not inclined toward the axis of the cylinder.

The air swirl 150 within the bowl 105 is in the same rotation direction (sense of rotation) as the rotation direction of the liquid fuel 130A that is travelling along the curvature of the wall 147. Therefore, the air swirl 150 aids the travel and rotation movement of the liquid fuel 130A along the curvature of the wall 147. On the other hand, if there is sufficient pressure (energy) that is provided by the injector 120 to the plume 130, then the liquid fuel 130A will not have to significantly rely on the air swirl 150 for travel and entrainment along the curvature of wall 147.

The squish area 117 of the bowl 105 will accelerate and increase the velocity of the air swirl 150 (and the air charge portion in the swirl) around the combustion chamber 107. The air swirl 150 will accelerate because the diameter of the combustion chamber 107 decreases from the piston crown 154 of the bowl 105 to the lower portions of the bowl 105. The swirl number is the ratio of the angular speed (i.e., rotation rate or omega) of the air charge portion and the angular speed of the crankshaft. The swirl number is typically, for example, at a value of approximately 1 or more.

As also shown in FIG. 1A, on most portions of the circumference of the piston bowl 105, the distance from the center 145 to the wall 147 is the first radius r. For example, as shown in FIG. 1, the distance from the center 145 to each of the wall portions 160, 162, 164, 168, and 174 is the radius r.

The wall portion 162 of the wall 147 has the radius distance r from the center 145. Moving along the wall 147 in a counter-clockwise direction in FIG. 1A, the wall portion 170 is shown as being on a first side 171 of the ignition source pocket 115 along the wall 147. The distance from center 145 to the wall portion 170 is the radius r1, where r1<r. Therefore, the radius of the bowl 105 (i.e., distance r from center 145 to the wall 147) will vary and have different values.

The wall portion 172 is on a second side 173 of the ignition source pocket 115 along the wall 147. The second side 173 is on an opposed side of the pocket 115 from the first side 171. The distance from center 145 to the wall portion 172 is the radius r2, where r2>r. Therefore, the first wall portion 170 and the second wall portion 172 are not on a same circumference path but are offset by a first offset distance, OF1 as shown in equation (1).

OF1=r2−r1 (1)

Since the first wall portion 170 and the second wall portion 172 are not on a same circumference path but are offset by the first offset distance, OF1=r2−r1, fuel 130A that is entrained on and is travelling along the wall portion 171 will be lifted (pulled) in a direction towards the center 145. Therefore, the wall portion 170 effectively functions as a ramp for the liquid fuel 130A in order to prevent the liquid fuel 130A from falling (moving) into the ignition source pocket 115 and to prevent the liquid fuel 130A from hitting the wall (edge) 116 of the pocket 115. The liquid fuel 130A will jump over the pocket 115 and land on the wall portion 172 and continue its rotation and tangential movement along the wall 147. Since the wall portion 172 has the radius r2, where r2>r, the offset distance OF1 (where OF1=r2−r1) permits the liquid fuel 130A to have an additional distance of r2−r1 for landing on the wall portion 172 after the fuel 130A has jumped over the pocket 115.

As also shown in FIG. 1A, the distance from center 145 to the wall portion 164 and to the wall portion 168 are each at the radius r.

Moving along the wall 147 in a counter-clockwise direction in FIG. 1A, the wall portion 174 is shown as being on a first side 175 of the injector pocket 110 along the wall 147. The distance from center 145 to the position 174 is the radius r3. In an embodiment of the invention, the radius r3 is less than r (r3<r). However, in other embodiments of the invention, the radius r3 can also be equal to r (r3=r).

The wall portion 175 is on a second side 176 of the injector pocket 110 along the wall 147. The second side 176 is on an opposed side of the pocket 110 from the first side 175. The distance from the center 145 to the wall portion 175 is the radius r. Therefore, in an embodiment of the invention where r3<r, the first wall portion 175 and the second wall portion 176 are not on a same circumference path but are offset by a second offset distance, OF2 as shown in equation (2).

OF2=r−r3. (2)

If r3<r, then liquid fuel 130A travelling at wall portion 174 will be lifted toward center 145, will be able to jump over the pocket 110, will then land on the wall portion 175, and then continue its rotation and tangential movement along the wall.

In an embodiment of the invention, the curvature of the wall side 171 (adjacent to ignition source pocket 115) is increased in order to have a ramp configuration. The ramp configuration also helps to lift up the liquid fuel 130A away from the pocket 115 and substantially prevent the movement (or splashing) of the liquid fuel 130A into the pocket 115. However, in another embodiment of the invention, this ramp-like shape is omitted and only the configuration r2>r1 is used to lift the liquid fuel 130A away from the pocket 115.

The pocket 115 is shaped and has dimensions that will draw the vaporized fuel 130B from the liquid fuel 130A that is rotating along the wall 147. As the liquid fuel phase 130A jumps over the pocket 115, the vaporized fuel phase 130B will move within the pocket 115. The liquid fuel phase 130A and the vaporized fuel phase 130B will have opposite senses of rotation. Therefore, the sense of rotation of the charge motion of the vaporized fuel and air in the pocket 115 will be opposite to the sense of rotation of the liquid fuel 130A along the piston bowl wall 147. For example, if the liquid fuel phase 130A is rotating counter-clockwise along wall 147, then the vaporized fuel phase 130B will rotate clockwise within the pocket 115, and vice versa. The flow within the pocket 115 will be the vaporized fuel phase 130B and some air mixture in the vaporized fuel phase 130B. The dimension of the ignition pocket 115 is sufficiently narrow so that the backflow due to the vaporized fuel 130B and entrained air in the vaporized fuel 130B will not disturb the flow of the liquid fuel 130A along the wall 147. The ignition source 130 provides ignition catalyst 180 (e.g., spark) that ignites the vaporized fuel 1308 for starting combustion.

Since the liquid fuel phase 130A will not impinge within the pocket 115 and will not come into contact with the ignition source tip 131, the liquid fuel will not short-circuit the insulator of a spark source that may be implemented as an ignition source 130. As a result, the ignition source 130 will be able to function properly by providing the ignition catalyst 180 (e.g., spark) to ignite the vaporized fuel phase 130B.

In an embodiment of the invention, one wall of the pocket 115 can be shaped as an undercut 182A. This undercut 305A provides a cover to shield the ignition source tip 131 from splashes of liquid fuel 130A that is entrained along the wall 147. The opposed edge 116 of the pocket 115 is typically straight in configuration.

The undercut 182A covers (or partially covers) the tip 131 so that a center axis line 183 of the tip 131 will intersect a curved portion 184A of the undercut 182A. Therefore, the curved portion 184A provides the tip 131 as a cover or shield of any liquid fuel 130A.

The following parameters may be used as example dimensions in the piston bowl 105 and are, therefore, not intended to limit the embodiments of the invention.

The injector pocket 110 is preferably narrow in dimension in order to reduce the air volume that may be entrained from the piston bowl wall 147 toward the inside of the pocket 110 and to not sufficiently deteriorate the compression ratio.

FIG. 1B is a top view of a piston bowl 105A in accordance with another embodiment of the invention. The piston bowl 105A has an ignition source pocket 115A which does not have the undercut 182A of FIG. 1A. Instead, the pocket 115A will have a straight or substantially straight side 182B without an undercut.

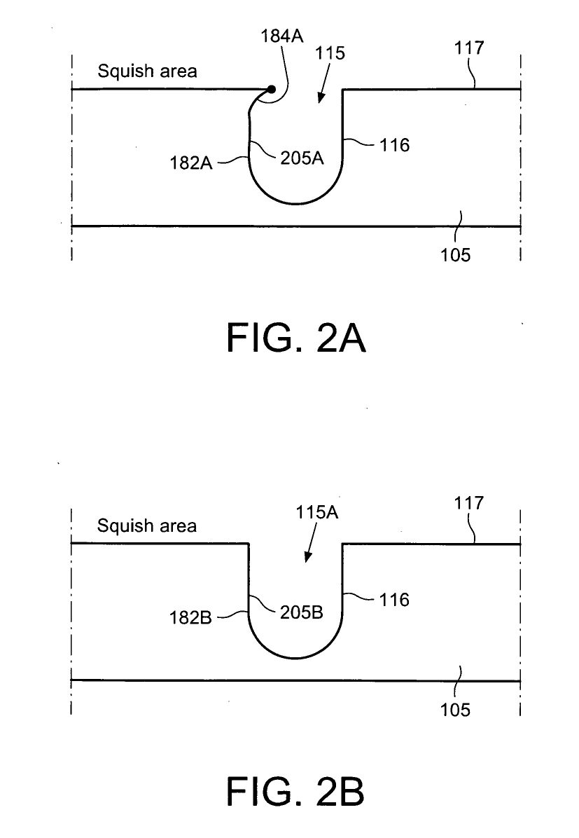

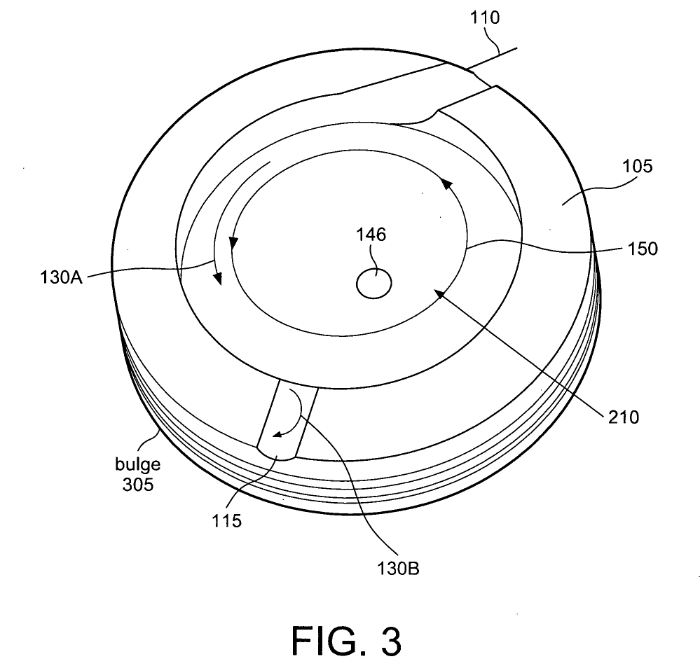

FIGS. 2A and 2B are partial side elevational views of piston bowls in accordance with various embodiments of the invention. The piston bowl 105 of FIG. 2A has the ignition source pocket 115 with the undercut 182A on a pocket wall 205A. In contrast, the piston bowl 105B of FIG. 2B has the ignition source pocket 115A with the non-undercut shape 182B on a pocket wall 205B.

The configuration of the piston bowls 105/105A can be achieved by use of conventional casting techniques, numerical control (NC) machining, or/and other standard manufacturing techniques for the manufacture of pistons. Additionally, the materials used for the piston bowl 105 can be any suitable material used for standard pistons such as, for example, metals, irons, alloys, or combinations of metals, irons, alloys, and/or other suitable materials.

In an embodiment of the invention as shown in FIG. 1A, the center portion 146 of the piston bowl 105 is substantially flat. However, in another embodiment of the invention as shown in FIG. 3, the center portion 146 of the piston bowl 105 can have a bulge 305 in order to increase the compression ratio ε.

The formula for peak compression pressure is shown in equation (1)

P_{cp}=P₀*ε^{Y} (1)

where, P0 is the boost pressure, cis the compression ratio, and Y is the polytropic exponent. The boost pressure P₀ can be achieved by use of, for example, a conventional turbo-charge stage or conventional super-charge stage. The polytropic exponent Y is typically approximately 1.4 for air and is normally in the 1.36 to 1.38 range. The compression ratio can have a value of, for example, 14/1 or other suitable high compression ratio value. The boost pressure can be in the range of, for example, approximately 2.5 bar to approximately 3.0 bar. Based on the above equation (1), the peak compression pressure can be in the range of, for example, approximately 100 bar to 144 bar. In order for the fuel injection to overcome the back pressure in the combustion chamber 107, the pressure of the fuel plume 130 must be greater than P_{cp}. In other words, the pressure of the fuel plume 130 is typically required to be at least approximately 100 bar.

It is difficult to produce a pressure of 1000 bar with ethanol because the lubrication capability of ethanol is very poor and a high pressure mechanical pump has a high amount of friction and very little or no lubrication. On the other hand, it is less difficult and more economical for a GDI injector to produce a pressure amount in the range of about 200 to 300 bar. Note that a diesel injector is also much larger in size and more expensive than a GDI injector. For example, a typical diesel injector is approximately three times larger and approximately five times more expensive than a typical GDI injector. Therefore, one advantage that is provided by an embodiment of the invention is that a very high pressure is not required for an injector 120 to be used with the piston bowl 105. As a result, the smaller sized and relatively less expensive GDI injector type can be used advantageously in an embodiment of the invention.

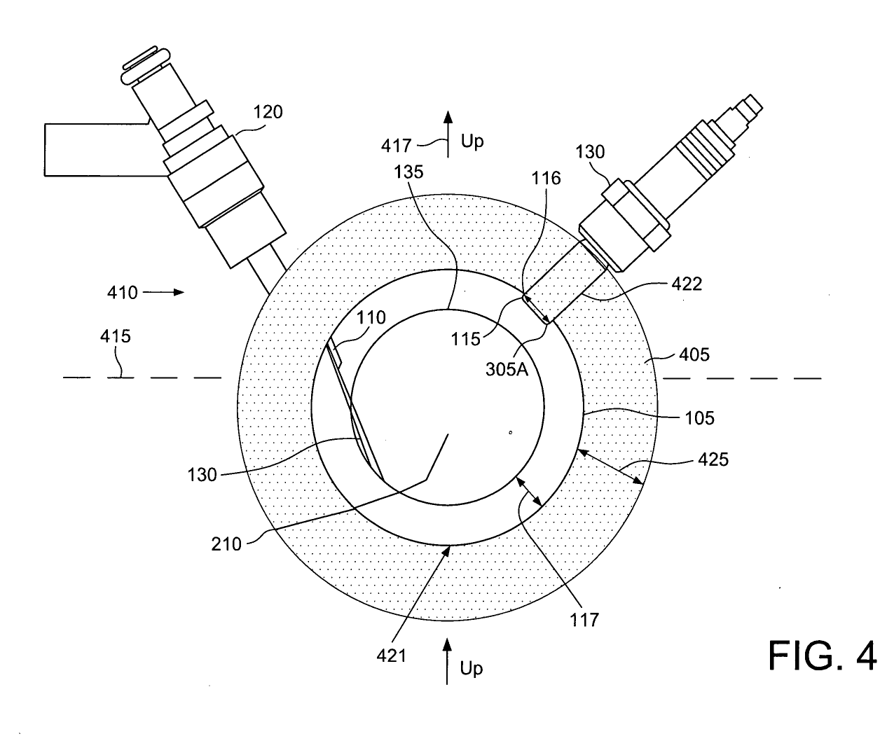

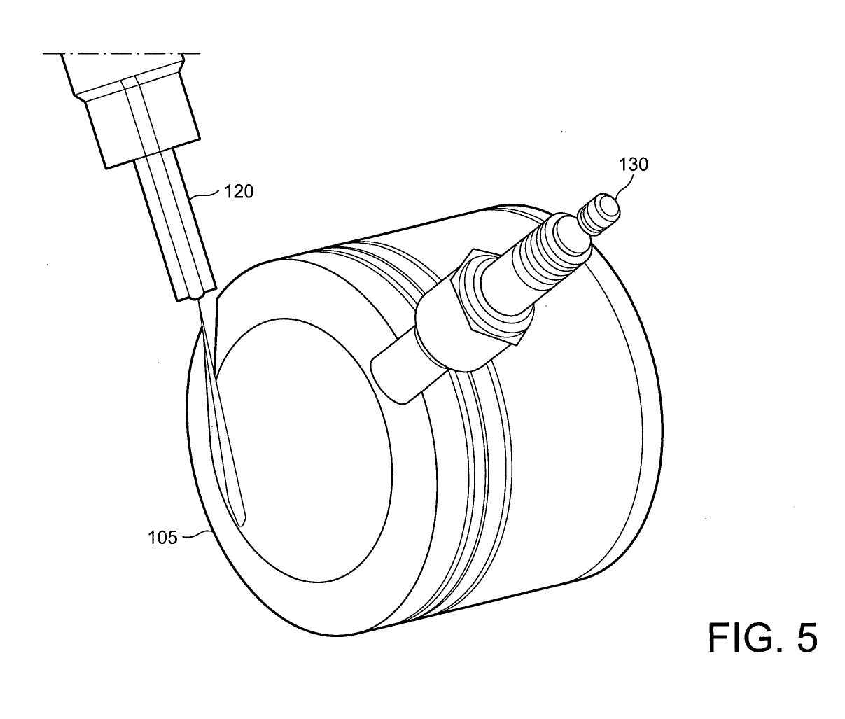

FIG. 4 is an axial cross-sectional view of the piston bowl 105 as implemented with a cylinder 405 in a horizontal layout, in accordance with an embodiment of the invention. For a cylinder 405 in a horizontal layout, the ignition source 130 and injector 120 are positioned in an upper portion 410 with respect to a bore of the cylinder 405. The upper portion 410 is a position above the horizontal reference line 415 as shown in FIG. 4. The upward direction is shown by reference arrow 417. Since the ignition source 130 (shown as a non-limiting example of a spark plug in FIG. 4) and the injector 120 are positioned in the upper portion 410, it follows that the injection pocket 110 (FIG. 1) and ignition source pocket 115 (FIG. 1) are also located in the upper portion 410. As a result, any liquid fuel 130A that loses its momentum of rotation around the chamber wall 147 will not fall into the pockets 110 and 115.

FIG. 4 also shows the squish area 117 at the piston crown. The threads 422 of the example spark plug are inserted through the cylinder liner 425 which is of a suitable thickness. Therefore, FIG. 4 shows an example of a portion of the injector source 130 as being mounted through the cylinder 405. A portion of the injector 120 is also mounted through the cylinder 405.

A recess in the squish area 117 may be required in one implementation, so that when the piston moves by the ignition source 130, the piston will not contact the tip of the ignition source 130. A multi-spark ignition source may be required to insure reliable ignition, if an opposing squish flow from that squish area recess would press the vaporized fuel and air away from the ignition source pocket 115. A multi-spark ignition source would also provide a reliable ignition start in the cold start situation, in the event that vaporization deteriorates during cold start.

The injector 120 is outside of the cylinder liner 425 so that the piston 105 can travel along the cylinder 105. The cylinder liner 425 will have open spaces to accommodate the injector 120 and the ignition source 130.

The tip 421 of the piston bowl is at the outer edge of the squish area 117. The squish area 117 is designed as an undercut so that the fuel does not come into contact or splash on the wall of the cylinder 405. It is desirable that fuel contact or fuel impingement does not occur on the inner wall of the cylinder 405 for the following reasons. First, the impinging fuel would dilute the lubrication oil on the inner wall of the cylinder 405 and would also come into contact with the crank case. Second, the impinging fuel would be wasted because this fuel will not be able to participate in combustion.

In an embodiment of the invention, the piston bowl is preferably in the center of the cylinder 405. However, in another embodiment, the piston bowl can be offset from the center of the cylinder 405.

FIG. 5 is an additional perspective view of the piston bowl 105, in accordance with an embodiment of the invention. In a horizontal cylinder layout, the injector 120 is, for example, approximately 35 degrees before top dead center (TDC) when the piston is, e.g., approximately 5 millimeters before TDC.

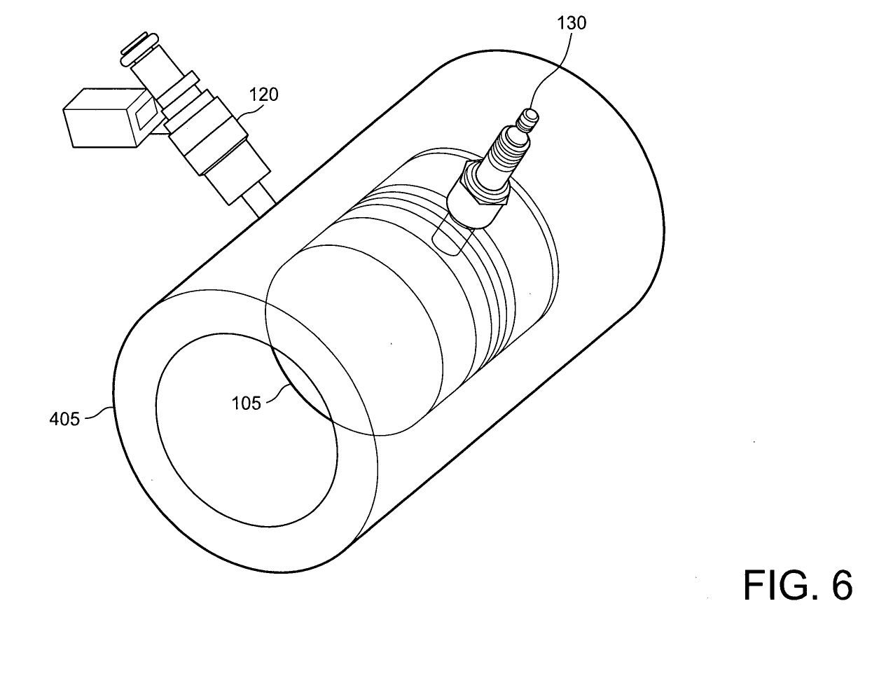

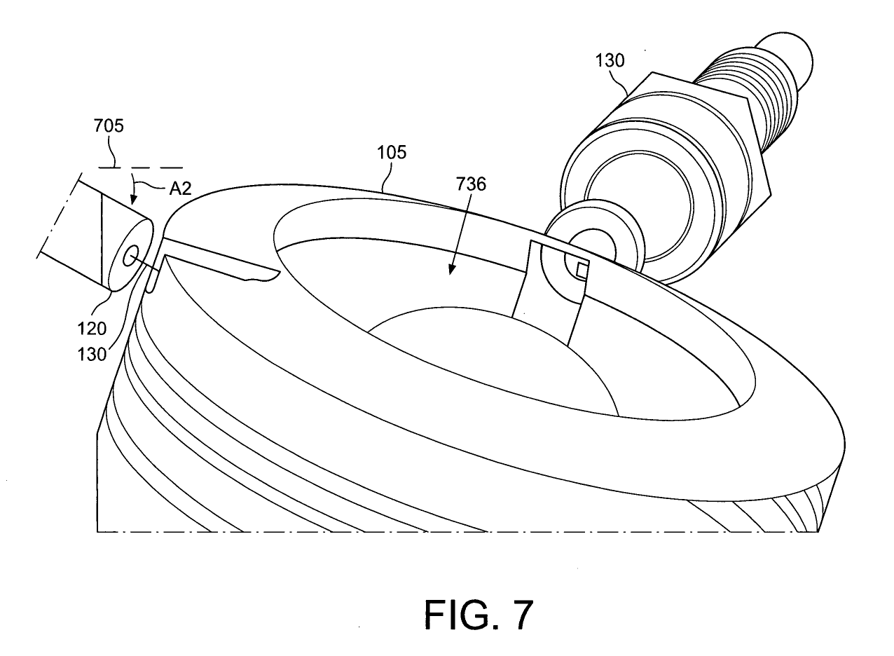

FIG. 6 is an additional isometric view of the piston bowl 105 in accordance with an embodiment of the invention. The piston 105 is viewed transparently through the cylinder 405, for purposes of clarity.

FIG. 7 is an additional perspective view of the piston bowl 105, in accordance with an embodiment of the invention. The tip of the injector 120 is shown in TDC. Preferably, the injector 120 is inclined at an injector incline angle A2 with respect to a reference line 705, so that the direction of the fuel plume (spray) 130 is inclined downward into the opening 736 of the piston bowl 105. In other words, the injector 120 is inclined toward the axis of the cylinder. The angle A2 can range from, for example, about 2 degrees to about 5 degrees.

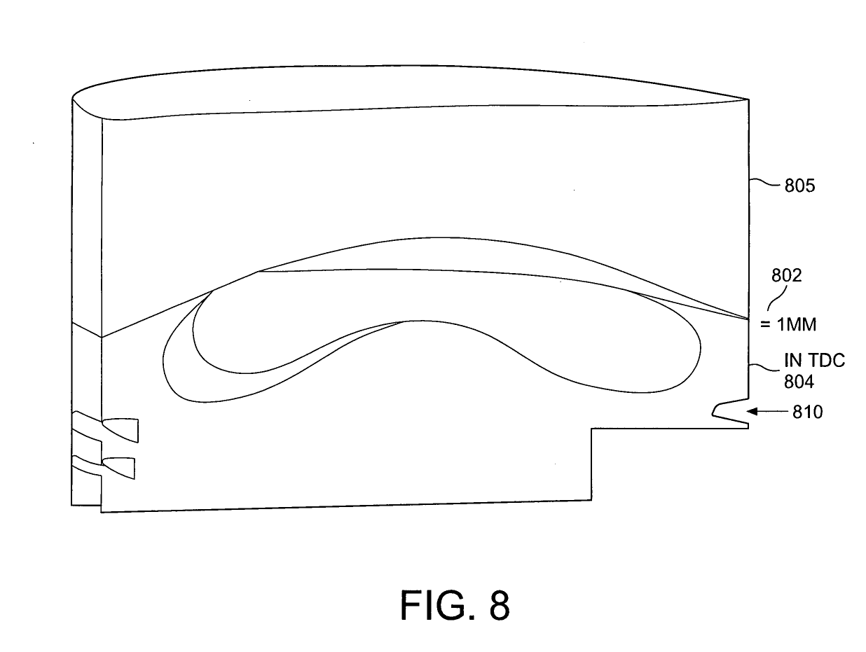

FIG. 8 is a cross-sectional view of an opposed piston arrangement that can be used in an embodiment of the invention. This opposed piston arrangement is one non-limiting example that can implement an embodiment of the invention. As mentioned above, an embodiment of the invention can also be implemented in a single piston per cylinder arrangement. A squish area 802 is between the exhaust piston 802 and the intake piston 805. The piston ring grooves 810 in the exhaust piston 804 are also shown in FIG. 8 as an additional detail. The squish area 802 can be, for example 1 mm in TDC. The various inventive features of the piston bowl, as previously discussed above, can be included in the opposed pistons 804/805.

Various advantages have been achieved with methanol turbo-charged direct injection diesel engines. First, cold start from −30 degrees was available. In contrast, cold start issues arise with standard ethanol engines.

Second, smoke and carbon deposit were avoided as compared to a port injected engine with M85 (methanol 85%).

Third, a lower NOx is achieved as compared to diesel. Because of the cooling effect and a very little amount of EGR for this combustion, the engine knock problem is minimized.

Fourth, approximately 30% higher low speed torque is achieved at an air-fuel ratio of about 1.1, with no smoke production.

Fifth, the fuel consumption is similar to baseline diesel.

Sixth, combustion is robust with use of the wall guide concept (i.e., fuel entrainment on the combustion chamber wall). A precise air to fuel ratio is not required and non-throttle operation is available. Additionally, a relatively wide range of injection timing tolerance and ignition timing tolerance is permitted. Therefore, the use of a multi-spark ignition might be potentially eliminated.

As a result, various advantages are achieved by use of alcohol fuel.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A combustion chamber for non-soot emitting fuel, comprising:
a piston bowl; and
a fuel injector mounted through a cylinder wall of a cylinder with the piston bowl, wherein the fuel injector injects fuel against a wall of the piston bowl in at least a substantially tangential manner.

2. The combustion chamber of claim 1, wherein the fuel injector injects fuel against the wall of the piston bowl in a tangential manner.

3. The combustion chamber of claim 1, wherein the at least substantially tangential manner of fuel injection maintains a momentum of the fuel along the wall of the piston bowl and reduces a reflection of the fuel from the wall of the piston bowl.

4. The combustion chamber of claim 1, wherein the fuel injector is inclined toward an axis of the cylinder.

5. The combustion chamber of claim 1, wherein the fuel injector is not inclined toward an axis of the cylinder.

6. The combustion chamber of claim 1, wherein the fuel injector injects a focused plume of the fuel at a narrow angle.

7. The combustion chamber of claim 1, wherein the piston bowl includes a squish area that accelerates an air swirl in the piston bowl.

8. The combustion chamber of claim 1, wherein the piston bowl includes a middle portion that has a bulge that increases a compression ratio.

9. The combustion chamber of claim 1, wherein the piston bowl includes a middle portion that is flat.

10. The combustion chamber of claim 1, wherein the piston bowl has a high compression ratio value.

11. The combustion chamber of claim 1, wherein the piston bowl has a compression ratio value of at least approximately 14/1.

12. The combustion chamber of claim 1, wherein the piston bowl has a radius that varies at different values.

13. The combustion chamber of claim 1, wherein the different values of the radius prevent a liquid state of the fuel from moving into an ignition source pocket of the piston bowl.

14. The combustion chamber of claim 1, wherein the wall of the piston bowl comprises a first wall portion that is at a distance r from a center of the piston bowl.

15. The combustion chamber of claim 14, wherein the wall of the piston bowl comprises a second wall portion on a first side of an ignition source pocket; and
wherein the second wall portion is at a distance r1 from the center of the piston bowl, and wherein r1<r.

16. The combustion chamber of claim 15, wherein the wall of the piston bowl comprises a third wall portion on a second side of the ignition source pocket; and
wherein the third wall portion is at a distance r2 from the center of the piston bowl, and wherein r2>r.

17. The combustion chamber of claim 15, wherein the second wall portion on the first side of the ignition source pocket comprises a ramp configuration that substantially prevents a movement of the liquid state of the fuel into the ignition source pocket.

18. The combustion chamber of claim 1, further comprising an ignition source that provides ignition to vaporized fuel in an ignition source pocket of the piston bowl.

19. The combustion chamber of claim 18, wherein the ignition source is mounted through the cylinder wall of the cylinder with the piston bowl.

20. The combustion chamber of claim 1, wherein the piston bowl includes an ignition source pocket that substantially draws vaporized fuel from the fuel that is entrained along the wall of the piston bowl.

21. The combustion chamber of claim 20, wherein the ignition source pocket does not substantially draw a liquid state of the fuel that is entrained along the wall of the piston bowl.

22. The combustion chamber of claim 1, wherein the fuel that is entrained along the wall of the piston bowl is at a same sense of rotation as an air swirl in the piston bowl.

23. The combustion chamber of claim 1, wherein the fuel that is entrained along the wall of the piston bowl has a sense of rotation that is opposed to a sense of rotation of vaporized fuel and air in an ignition source pocket of the piston bowl.

24. The combustion chamber of claim 1, wherein the piston bowl includes an ignition source pocket having a wall with an undercut.

25. The combustion chamber of claim 24, wherein the undercut that substantially shields an ignition source from a liquid state of the fuel that is entrained along the wall of the piston bowl.

26. The combustion chamber of claim 1, wherein the piston bowl includes an ignition source pocket having a wall without an undercut.

27. The combustion chamber of claim 1, wherein the piston bowl includes an ignition source pocket and a fuel injection pocket are both positioned in an upper half relative to a bore of the cylinder, if the cylinder is in a horizontal layout

28. The combustion chamber of claim 1, wherein the fuel comprises alcohol fuel.

29. The combustion chamber of claim 1, wherein the fuel comprises one of ethanol, methanol, ISO buthanol, or D.M.E.

30. The combustion chamber of claim 1, wherein the fuel comprises ammonia.

31. The combustion chamber of claim 1, wherein the piston bowl includes a squish area that prevents contact of the fuel with an inner wall of the cylinder.

32. A method for using injecting non-soot emitting fuel in a combustion chamber, the comprising:
providing a piston bowl;
providing a fuel injector mounted through a cylinder wall of a cylinder with the piston bowl; and
injecting fuel against a wall of the piston bowl in at least a substantially tangential manner.
